(19) United States
(12) Patent Application Publication
(10) Pub. No.: US 2026/0205778 A1
(43) Pub. Date: Jul. 16, 2026

(54) METHODS, ARCHITECTURES, APPARATUSES AND SYSTEMS FOR WTRU SENSING MONITORING IN WIRELESS SYSTEMS

(71) Applicant: InterDigital Patent Holdings, Inc., Wilmington, DE (US)

(72) Inventors: Filipe Conceicao, London (GB); Sebastian Robitzsch, London (GB); Muhammad Awais Jadoon, London (GB); Abinaya Babu, Illford (GB); Ulises Olvera-Hernandez, Saint-Lazare (CA); Jung Je Son, Warrington, PA (US)

(21) Appl. No.: 19/017,181

(22) Filed: Jan. 10, 2025

(51) Int. Cl. H04W 4/38; H04L 41/14; H04L 41/16; H04L 41/5009

(52) U.S. Cl. CPC H04W 4/38; H04L 41/14; H04L 41/16; H04L 41/5009

(57) ABSTRACT

The present disclosure is related to WTRU sensing monitoring in wireless systems. The WTRU may receive sensing configuration information and perform first sensing measurements based on the sensing configuration information. The WTRU may transmit a first report based on the first sensing measurements. The WTRU may receive a request to activate an analyzing function, wherein the analyzing function may evaluate at least one key performance indicator (KPI) criteria. The WTRU may perform, after receiving the request, second sensing measurements to determine at least one KPI. The WTRU may determine, based on the at least one KPI, that the at least one KPI criteria is met. The WTRU may transmit, based on the at least one KPI criteria being met, a second report based on the second sensing measurements.

### BACKGROUND

A wireless transmit/receive unit (WTRU) may generate and report sensing data, sensing results, related contextual information, or any combination thereof to the network in order for the network to determine whether sensing key performance indicator (KPI) requirements are currently being met. For situations in which KPI requirements are not being met and, for example, additional resources cannot be allocated (e.g., due to system usage overload, policies that cap resource usage), continuing to report sensing data, sensing results, related contextual information, or any combination thereof may result in wasted system resources and energy across the entire system.

### SUMMARY

The present disclosure is generally directed to the fields of communications, software and encoding, including, for example, to methods, architectures, apparatuses, systems related to WTRU sensing monitoring in wireless systems. This disclosure may provide a method performed by a WTRU and a WTRU for sensing monitoring. In accordance with certain embodiments of the present disclosure, the WTRU receives sensing configuration information, performs first sensing measurements based on the sensing configuration information, and transmits a first report based on the first sensing measurements. The WTRU may receive a request to activate an analyzing function, wherein the analyzing function may evaluate at least one key performance indicator (KPI) criteria. As used herein, the term criteria may refer to a single criterion or a plurality of criteria. In accordance with certain embodiments of the present disclosure, the WTRU performs, after receiving the request, second sensing measurements to determine at least one KPI. The WTRU determines, based on the at least one KPI, that the at least one KPI criteria is met. The WTRU transmits, based on the at least one KPI criteria being met, a second report based on the second sensing measurements.

In some embodiments, the WTRU suspends, after receiving the request, transmission of sensing reports.

In some embodiments, the WTRU transmits, after determining that the at least one KPI criteria is met, an indication that the at least one KPI criteria is met. In some embodiments, the WTRU receives, after transmitting the indication that the at least one KPI criteria is met and before transmitting the second report, a request to start transmitting sensing reports.

In some embodiments, the request to activate the analyzing function is based on a detection of a KPI violation.

In some embodiments, determining that the at least one KPI criteria is met is based on an output of a machine learning model.

In some embodiments, the at least one KPI comprises an error metric and the at least one KPI criteria comprises a threshold value for the error metric.

In some embodiments, the request to activate the analyzing function comprises an indication of the at least one KPI criteria.

In some embodiments, the sensing configuration information comprises the at least one KPI criteria.

In some embodiments, the first report and the second report are transmitted to a sensing analytics function of a core network.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative diagram of sensing functionalities, according to some embodiments of this disclosure;

FIG. 3A is a first portion of an illustrative table of examples of sensing KPIs, according to some embodiments of this disclosure;

FIG. 3B is a second portion of an illustrative table of examples of sensing KPIs, according to some embodiments of this disclosure;

FIG. 3C is a third portion of an illustrative table of examples of sensing KPIs, according to some embodiments of this disclosure;

FIG. 4 is an illustrative flow diagram of steps for activating and de-activating WTRU sensing functionalities, according to some embodiments of this disclosure;

FIG. 5 is an illustrative WTRU-based sensing functionalities state machine diagram, according to some embodiments of this disclosure; and

FIG. 6 is an illustrative flow diagram of steps for WTRU sensing monitoring in wireless systems, according to some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

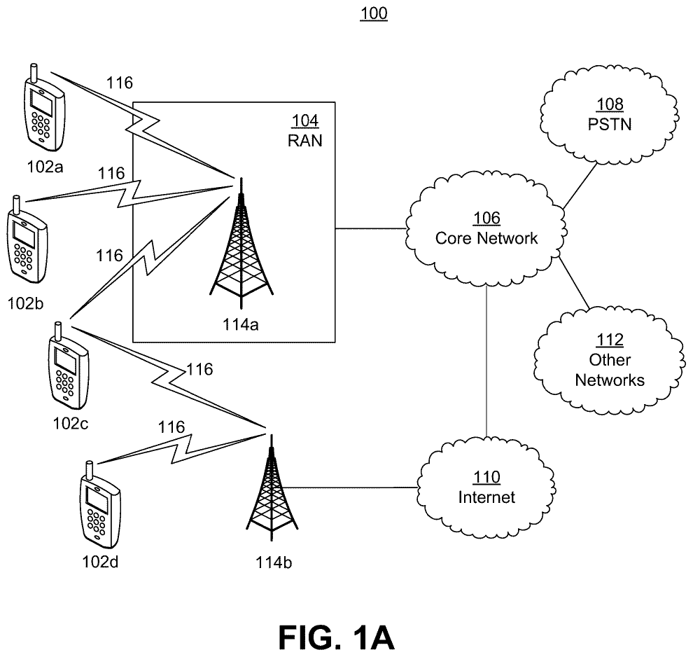

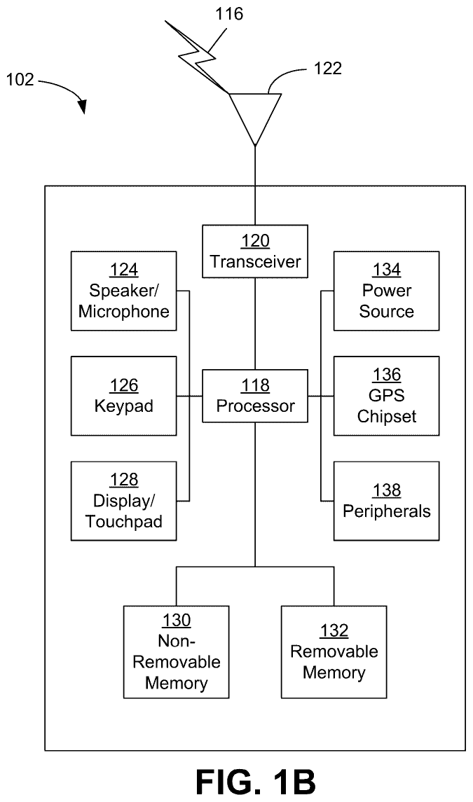

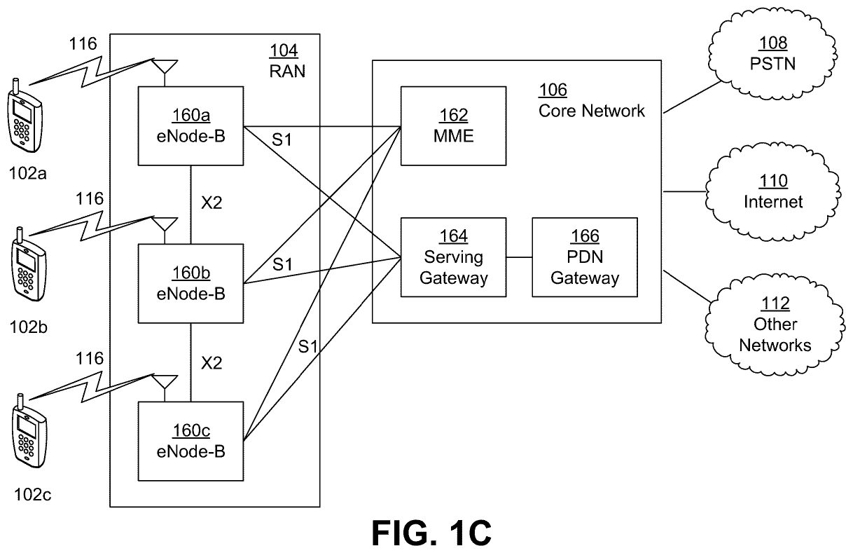

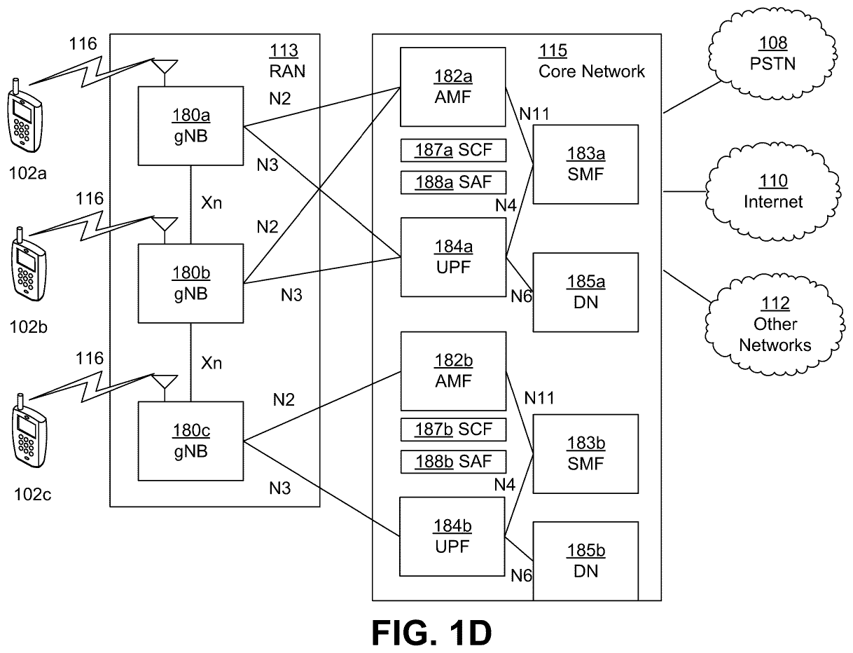

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, at least one Data Network (DN) 185a, 185b, at least one Sensing Coordination Function (SCF) 187a, 187b, and at least one Sensing Analytics Function (SAF) 188a, 188b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In accordance with some embodiments of this disclosure, methods and systems for the WTRU triggering the reporting of sensing data, sensing results, contextual information, or any combination thereof upon determination that sensing KPI requirements are being met are provided as follows. In some embodiments, the WTRU receives a sensing request from a core network (e.g., from the SCF 187a, 187b) with monitoring criteria for KPI requirements. The KPI requirements may include one or more of the following: a) criteria for the WTRU to start reporting on sensing data, sensing results, contextual information, or any combination thereof (e.g., the criteria may include sensing related determination rules that are relevant for sensing use cases), b) criteria including analytics capabilities and related determination rules for the WTRU to operate on sensing data, sensing results, contextual information, or any combination thereof(or c) configuration including a request for the WTRU to report on sensing data, sensing results, contextual information, or any combination thereof.

The WTRU may start reporting on sensing data, sensing results, contextual information, or any combination thereof to the core network (e.g., to SAF 188a, 188b).

The WTRU may receive a request from the core network (e.g., SCF 187a, 187b) to activate one or more state machine functionalities, which may include one or more of an indication to not report, an indication to start analytics, or an indication to stop sensing.

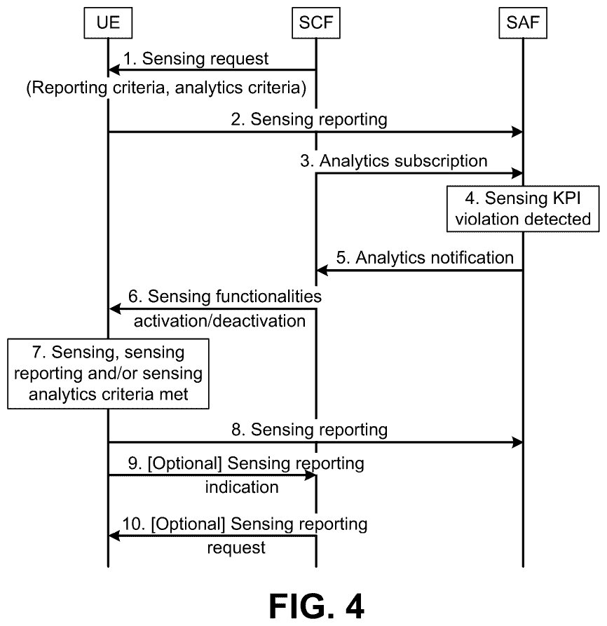

In some embodiments, the indication to not report may be an indication to not report on sensing data, sensing results, contextual information, or any combination thereof (e.g., R_SUSPEND 420 of FIG. 4).

In some embodiments, the indication to start analytics may be an indication to start one or more analytics engines (e.g., an analyzing function) to perform assessment of KPIs for sensing results (e.g., A_CONFIG 410 of FIG. 4 for choice of engines, A_EXECUTE 412 of FIG. 4 for executing engines).

In some embodiments, the indication to stop sensing may be an indication to stop generating sensing data (e.g., S_IDLE 402 of FIG. 4), in which case the WTRU may require a new request from the SCF to start reporting on sensing data, sensing results, contextual information, or any combination thereof. The WTRU may evaluate whether criteria for reporting, analyzing, performing sensing, or any combination thereof is met. The evaluation may be based on received an indication and may depend on the state combination in the state machine. The WTRU may optionally transmit to, for example, the SCF one or more of the following indications: a) an

indication of whether criteria for reporting of sensing data, sensing results, contextual information, or any combination thereof is met, b) an indication of whether the criteria for stopping sensing is met, or c) an indication of whether the criteria provided (e.g., by the SAF) for the WTRU to assess sensing KPIs and/or analytics results is met.

The WTRU may optionally receive a request from the SCF to start reporting sensing data, sensing results, contextual information, or any combination thereof.

The WTRU may trigger the reporting on sensing data, sensing results, contextual information, or any combination thereof. The triggering may be based on the WTRU evaluation of whether criteria for reporting, analyzing, performing sensing, or any combination thereof is met.

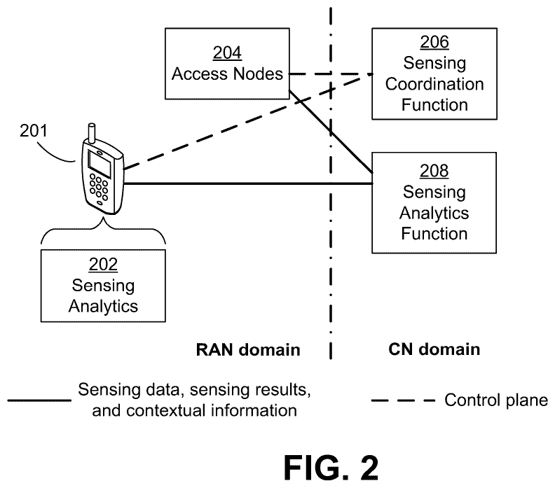

FIG. 2 is an illustrative diagram of sensing functionalities, according to some embodiments of this disclosure.

Implementation of sensing features may involve new system functionalities. These system functionalities may be included in future generation mobile network systems with the ability to be sensing-enabled. Accordingly, the sensing functionalities may be enablers to achieving certain objectives for a broader sensing operation. FIG. 2 depicts such sensing functionalities. The illustration of FIG. 2 does not necessarily define the sensing functionalities as new mobile network entities.

The SCF (e.g., SCF 187a, 187b, 206) coordinates the sensing operation. The coordination may include full management of sensing sources of sensing data, non-3GPP sensing data, sensing results, sensing contextual information, or any combination thereof. The sensing contextual information may include source selection, activation, de-activation, configuration and activation/de-activation of reporting from sources. The sources may be an individual sensing transmitter, receiver, or sensing group. The SCF may manage the activation/de-activation and/or switching of sensing modes. The SCF may be a logical entity, a dedicated network function, or any combination thereof.

The SAF (e.g., 188a, 188b) may perform analytics over sensing data and/or process sensing results, based on the collected sensing data and/or results. The SAF may generate additional sensing data, sensing results, sensing contextual information, or any combination thereof. The SAF may generate insights from sensing data, sensing results, contextual information, or any combination thereof (e.g., by means of the application of statistical, probabilistic, or AI/ML methods). The SAF may perform fusion of sensing data from multiple sources. For example, the SAF may combine different sensing data, sensing results, contextual information, or any combination thereof from any sensing source (e.g., multiple WTRUs) and may generate further data/results from that fusion process. The SAF may also be able to expose the gathered or generated information to application servers in a Data Network (DN) (e.g., via the Network Exposure Function (NEF), to an Application Function (AF)). The SAF may be a logical entity, a dedicated network function, or any combination thereof. In some embodiments, the SAF functionalities may be embedded in the Network Data Analytics Function (NWDAF).

Assessments may be performed in the network (e.g., in the core network). The WTRU entering a monitoring state may temporarily transfer of some of the SAF functionalities to the WTRU.

As used herein, access nodes (e.g., access nodes 204) may refer to any radio access node, regardless of the wired or wireless technology used, and may be a WTRU (e.g., in the case of WTRU-to-network relay).

The presented functionalities may reside within the CN or elsewhere (e.g., in the RAN domain). FIG. 2 depicts, for example, sensing analytics 202 being performed by the WTRU 201, in accordance with some embodiments of this disclosure. The sensing analytics 202 may be some of the functionalities of SAF 202 that are being performed by WTRU 201.

FIG. 2 depicts a) sensing data, sensing results, and contextual information being generated and transmitted from a WTRU 201 to the SAF 208, and b) the SAF 208 and the SCF 206 communicating with each other, for the purpose of the exchange of relevant information, in accordance with some embodiments of this disclosure.

Sensing is a new feature that may be introduced in 6G systems. In 3GPP, some definitions have been adopted and are used herein for the purposes of describing embodiments of the invention. As used herein, 5G and NR should be understood as examples only, as 6G systems are considered in this disclosure.

3GPP sensing data may refer to any data derived from 3GPP radio signals impacted (e.g., reflected, refracted, diffracted) by an object or environment of interest for sensing purposes, and may be optionally processed within the 5G system. Radio signals from any other RAT, not just 3GPP (e.g., wi-fi, IEEE 802.15.4), may be considered to be 3GPP sensing data.

Non-3GPP sensing data may refer to any data provided by non-3GPP sensors (e.g., video, LiDAR, sonar) about an object or environment of interest for sensing purposes.

Sensing results may refer to any processed 3GPP sensing data requested by a service consumer.

Sensing contextual information may refer to any information that is exposed with the sensing results by a 5G system to a third-party (e.g., a trusted third-party), which may provide context to the conditions under which the sensing results were derived. Sensing contextual information may not contain 3GPP sensing data.

5G wireless sensing may refer to any 5G system feature providing capabilities to obtain information about characteristics of the environment and/or objects within the environment (e.g., shape, size, orientation, speed, location, distances or relative motion between objects). The 5G wireless sensing may use NR radio frequency signals, which, in some cases, may be extended by information created via previously specified functionalities in Evolved Packet Core (EPC) and/or Evolved Universal Terrestrial Radio Access Network (E-UTRAN).

Sensing assistance information may refer to any information that is provided to the 5G system from a third-party (e.g., a trusted third-party) and may be used to support the derivation of a sensing result. This information may not contain 3GPP sensing data.

Sensing group may refer to any set of sensing transmitters and/or sensing receivers whose location is known and whose sensing data may be collected synchronously.

Sensing receiver may refer to any entity that receives the sensing signal which a sensing service will use in its operation. A sensing receiver may be part of a RAN node or a WTRU. A sensing receiver may be located in the same or different entity as the sensing transmitter.

Sensing signals may refer to any transmissions on the 3GPP radio interface that may be used for sensing purposes.

Sensing transmitter may refer to any entity that sends out the sensing signal which a sensing service will use in its operation. A sensing transmitter may be part of a RAN node or a WTRU. A sensing transmitter may be located in the same or different entity as the sensing receiver.

Target sensing service area may refer to any area that may be sensed by deriving characteristics of the environment and/or objects within the environment with certain sensing service quality from the impacted (e.g., reflected, refracted, diffracted) 3GPP radio signals. This may include indoor and/or outdoor environments.

Sensing modes may refer to any monostatic, bi-static, multi-static sensing, or any combination thereof, regardless of the sensing transmitter and receiver pair (e.g., in a setup with a WTRU and a base station, in a setup with a WTRU1 and WTRU2 setup, both WTRU/BS or both WTRU1/WTRU2 may be the transmitter or the receiver).

Sensing KPIs may refer to any measure of quality of sensing results, where sensing results may be processed or unprocessed sensing data. A sensing result quality may relate to an integrity of the measurement (e.g., accuracy or precision). The sensing result quality may be an assessment of the suitability and/or reliability of a sensing data result. The sensing result quality may be measured using a variety of methodologies and/or metrics. Metrics may include error percentages, errors margins, which are commonly used statistical measures for error difference between ground truth values (if available), measured values (e.g., Root Mean Squared Error (RMSE)), estimator function related error calculations, or any combination thereof. Different methodologies may include assessment of one or more samples of any sensing data result and their contextual information, by the application of any heuristic, statistical, probabilistic or AI/ML related methods.

Sensing KPIs may include positioning integrity, which is a measure of the trust in the accuracy of position-related data provided by a positioning system and the ability to provide timely and valid warnings to the location services (LCS) client when the positioning system does not fulfil the condition for intended operation.

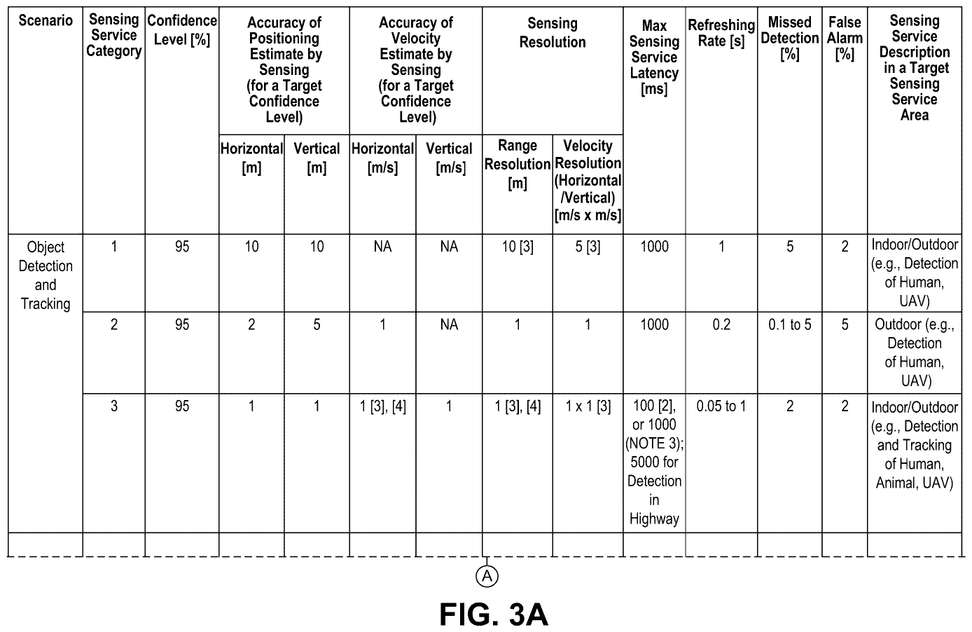

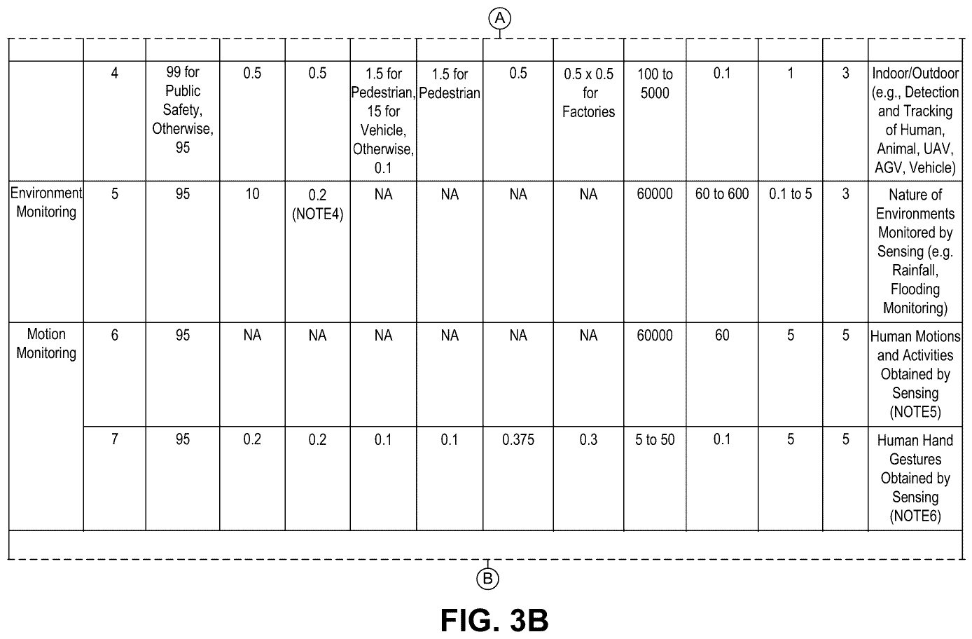

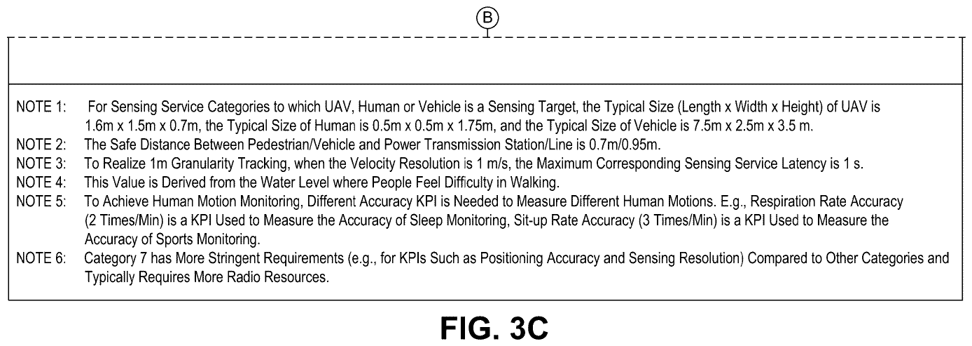

In accordance with some embodiments of this disclosure, examples of sensing KPIs are shown in FIGS. 3A, 3B, and 3C.

The table of FIGS. 3A, 3B, and 3C includes details on confidence levels, accuracy of positioning and velocity estimates, sensing resolution, maximum sensing service latency, refreshing rate, missed detection, and false alarm rates. The scenarios vary in terms of the precision required for horizontal and vertical positioning, velocity estimates, and the specific requirements for different applications such as public safety, pedestrian tracking, and short-range radar.

In Scenario 1 of FIG. 3A, the confidence level is 95%. The accuracy of the positioning estimate is 10 meters horizontally and 10 meters vertically. The accuracy of the velocity estimate is not applicable. The sensing resolution includes a range resolution of 10 meters and a velocity resolution of 5 meters per second. The maximum sensing service latency is 1000 milliseconds, with a refreshing rate of 1 second. The missed detection rate is 5%, and the false alarm rate is 2%. The sensing service description in a target sensing service area may be indoor or outdoor (e.g., detection of a human and/or unmanned aerial vehicle (UAV)).

In Scenario 2 of FIG. 3A, the confidence level is 95%. The accuracy of the positioning estimate is 2 meters horizontally and 5 meter vertically. The accuracy of the velocity estimate is 1 meter per second both horizontally and is not applicable vertically. The sensing resolution includes a range resolution of 1 meter and a velocity resolution of 1 meter per second. The maximum sensing service latency is 1000 milliseconds, with a refreshing rate of 0.2 seconds. The missed detection rate is 0.1% to 5%, and the false alarm rate is 5%. The sensing service description in a target sensing service area may be outdoor (e.g., detection of a human and/or UAV).

In Scenario 3 of FIG. 3A, the confidence level is 95%. The accuracy of the positioning estimate is 1 meter horizontally and vertically. The accuracy of the velocity estimate is 1 meter per second horizontally and not applicable vertically. The sensing resolution includes a range resolution of 1 meter and a velocity resolution of 1 meter per second by 1 meter per second. The maximum sensing service latency is 100 milliseconds, 1000 milliseconds (see NOTE 3 of FIG. 3C), or 5000 milliseconds for detection in highway, with a refreshing rate of 0.05 seconds to 0.1 seconds. The missed detection rate is 2%, and the false alarm rate is 2%. The sensing service description in a target sensing service area may be indoor or outdoor (e.g., detection and tracking of a human and/or UAV).

In Scenario 4 of FIG. 3B, the confidence level is 99% for public safety and 95% for others. The accuracy of the positioning estimate is 0.5 meters both horizontally and vertically. The accuracy of the velocity estimate is 1.5 meters per second for pedestrians, 15 meters per second for vehicles, and 0.1 meters per second otherwise horizontally, and 1.5 meters per second for pedestrians and not applicable otherwise vertically. The sensing resolution includes a range resolution of 0.5 meters and a velocity resolution of 0.5 meters per second by 0.5 meters per second. The maximum sensing service latency is 100 milliseconds to 5000 milliseconds, with a refreshing rate of 0.1 second. The missed detection rate is 1%, and the false alarm rate is 3%. The sensing service description in a target sensing service area may be indoor or outdoor (e.g., detection and tracking of a human, animal, UAV, automated guided vehicle (AGV), any other vehicle, or combination thereof).

In Scenario 5 of FIG. 3B, the confidence level is 95%. The accuracy of the positioning estimate is 10 meters horizontally, and 0.2 meters vertically (see NOTE 4 of FIG. 3C). The accuracy of the velocity estimate is not applicable horizontally and not applicable vertically. The sensing resolution range resolution is not applicable and the velocity resolution is not applicable. The maximum sensing service latency is 60000 milliseconds, with a refreshing rate of 60 seconds to 600 seconds. The missed detection rate is 0.1% to 5%, and the false alarm rate is 3%. The sensing service description in a target sensing service area may be a nature of environments monitored by sensing (e.g., rainfall and/or flooding monitoring).

In Scenario 6 of FIG. 3B, the confidence level is 95%. The accuracy of the positioning estimate is not applicable horizontally and not applicable vertically. The accuracy of the velocity estimate not applicable both horizontally and is not applicable vertically. The sensing resolution range resolution is not applicable and the velocity resolution is not applicable. The maximum sensing service latency is 60000 milliseconds, with a refreshing rate of 60 seconds. The missed detection rate is 5%, and the false alarm rate is 5%. The sensing service description in a target sensing service area may be human motions and activities obtained by sensing (see NOTE 5 of FIG. 3C for additional information).

In Scenario 7 of FIG. 3B, the confidence level is 95%. The accuracy of the positioning estimate is 0.2 meters horizontally and 0.2 meter vertically. The accuracy of the velocity estimate is 0.1 meter per second both horizontally and is not applicable vertically. The sensing resolution includes a range resolution of 0.375 meters and a velocity resolution of 0.3 meter per second. The maximum sensing service latency is 5 milliseconds to 50 milliseconds, with a refreshing rate of 0.1 seconds. The missed detection rate is 5%, and the false alarm rate is 5%. The sensing service description in a target sensing service area may be human hand gestures obtained by sensing (see NOTE 6 of FIG. 3C for additional information).

Sensing KPIs may include object detection and tracking, environment monitoring, motion monitoring, or any combination thereof.

Sensing reporting may refer to any transmission of a report containing sensing data, sensing results, contextual information, or any combination thereof, in raw or processed form.

Statistically processed (e.g., via AI/ML) sensing data and/or sensing results may refer to any output of a statistical or inference method (e.g., AI/ML) over sensing data, sensing results, contextual information, or any combination thereof. Statistically processed sensing data and/or sensing results may be used to achieve a reduced and/or enhanced dataset, obtain statistical properties, obtain representation functions and their parameters, estimate values, fill missing values, use the statistical and/or any other mathematical method to obtain more or less sensing data, sensing results, contextual information, or any combination thereof.

FIG. 4 is an illustrative flow diagram of steps for activating and de-activating WTRU sensing functionalities, according to some embodiments of this disclosure.

In some embodiments, before the steps of FIG. 4 starts, it may be assumed that a sensing service request arrived at the network from an application, and sensing KPIs have either been communicated or derived by the SCF.

At step 1, the SCF (e.g., SCF 187a, 187b, 206) may send a configuration to the WTRU (e.g., WTRU 102a, 102b, 102c, 201). In some embodiments, the configuration includes criteria for sensing reporting and/or sensing analytics reporting. This configuration step may or may not include an indication for the WTRU to trigger the sensing reporting of sensing data, sensing results, contextual information, or any combination thereof. Step 1 is a first step in which the WTRU may be configured with reporting criteria and/or analytics criteria.

In some embodiments, the WTRU may be sending sensing reports, but not performing analytics. In such case, step 1 may represent a request for the WTRU to stop reporting and/or start performing analytics.

In some embodiments, the WTRU may be performing analytics, but not sending sensing reports (e.g., sensing data and/or sensing results). In such cases, step 1 may represent a request for the WTRU to start reporting and/or to stop performing analytics.

The WTRU may already have sensing reporting in execution. Criteria for the WTRU to assess sensing KPIs and to execute analytics over sensing data, sensing results, contextual information, or any combination thereof may also be included in the configuration received at step 1. In the remainder of the procedure of FIG. 4, it may be assumed that the criteria are produced by the SAF (e.g., SAF 188a, 188b, 208). Therefore, it may be assumed that the SAF has already provided this information to the SCF.

At step 2, the WTRU may start transmitting sensing reports to the SAF.

At step 3, the SCF may subscribe to notifications from the SAF related to future sensing KPI violation detections. In some embodiments, step 3 may occur immediately after step 1.

At step 4, the SAF may detect one or more of the sensing KPIs violations. Such an assessment may be based on the communicated sensing KPIs in the sensing service request and may be applied over the sensing reports and/or sensing results sent by the WTRU in step 2.

At step 5, the SAF may notify the SCF that the one or more sensing KPI requirements are not being met. In this case, the SCF may manage the WTRU.

At step 6, based on the previous notification from the SAF, the SCF may determine which functionalities to activate or de-activate in the WTRU. The choice of functionalities may vary depending on many factors, including the sensing use case. The WTRU may transmit sensing reports to the SAF. The SCF may send an indication to the WTRU to stop sensing reporting and to optionally execute analytics on sensing data and/or sensing results, independently of the indication to suspend sensing reporting. The sensing reporting suspension on the WTRU may be until a further notification from the SCF to resume (e.g., an indication to start sensing reporting again) is received by the WTRU or until the WTRU determines that the criteria for sensing reporting is met based on the criteria communicated by the SCF to the WTRU in Step 1.

For scenarios in which sensing data is being reported, the WTRU may perform the assessment of sensing data. Analytics assessment over sensing data may also be executed if the WTRU received that indication.

For scenarios in which sensing results are being reported, if the SCF instructs the WTRU to assess sensing KPIs, then the sensing KPIs may be communicated to the WTRU. The SCF (or the SAF, that would then communicate this to the SCF) may also make a determination about the sensing KPI (e.g., the KPI may be difficult to achieve for the particular WTRU) and may indicate to the WTRU to stop performing sensing altogether (e.g., S_STOP 506, A_STOP 514, R_STOP 522). If this happens, the WTRU may not perform sensing (i.e., the WTRU may not generate sensing data, sensing results, contextual information, or any combination thereof), and as a consequence, there may be no sensing data, sensing results, contextual information, or any combination thereof to perform analytics over.

The indication may contain a pointer (e.g., an ID) to certain analytics operations (e.g., an indication of at least one KPI criteria) the SCF wants the WTRU to perform. This may be in the case of network pre-configured operations and models. This may also be in the case that the analytics engines, analytics functions, analytics rules, or any combination thereof are already part of the WTRU implementation (e.g., have been registered previously by the WTRU in the network). Analytics may be performed over sensing data and/or sensing results,

At step 7, the WTRU may assess the sensing reporting criteria received in step 1 and may activate the assessment based on the indication in step 6. This is because it is considered that some of the indications given to the WTRU might have been pre-configured or registered by the WTRU in the network. Step 6 may also be considered for WTRU configuration.

At step 8, upon determining the criteria for sensing reporting are met, the WTRU may transmit the reports that meet the criteria to the network. This step may be dependent on the current WTRU state and what the WTRU is currently reporting or not reporting. For sensing reporting, the WTRU may be not sending reports to the network, and may trigger this reporting if any of the at least one criteria for sensing data, sensing results, sensing contextual information, or any combination thereof, is met or not met. For analytics reporting, the WTRU may not send analytics information to the network and may trigger the sending of this information upon determining that any of the at least one criteria for sensing data, sensing results, sensing contextual information, or any combination thereof, is met or not met.

In some embodiments, steps 9 and 10 may represent alternatives to step 8.

At step 9, depending on the functionalities active in the WTRU, the criteria that could be met may relate to sensing reporting and/or analytics. The WTRU may therefore indicate a sensing reporting criteria has been met and may send an indication to the SCF to notify it may report if requested. Steps 8 and 9 may be optional and may be applicable in different scenarios. For example, the sensing reporting criteria may be met but contents of the report are not currently necessary. The network may become aware that the sensing KPI requirements are met again and may choose when to request sensing reporting of sensing data, sensing results, contextual information, or any combination thereof from the WTRU.

The same applies to analytics determinations made by the WTRU. The WTRU may send an indication to flag that analytics related information are available.

If the WTRU determines it should stop sensing altogether, the WTRU may send an indication to the SCF that the WTRU has stopped executing sensing and/or that the WTRU would not provide any sensing reports and/or sensing results.

At step 10, the SCF may request from the WTRU to start sensing reporting and/or reporting of analytics information. There may be situations in which the network benefits from knowing which WTRUs could potentially transmit sensing reports and/or analytics reporting, without them being needed. This determination may be made by the SCF and may vary depending on the use case and/or the number of available WTRUs.

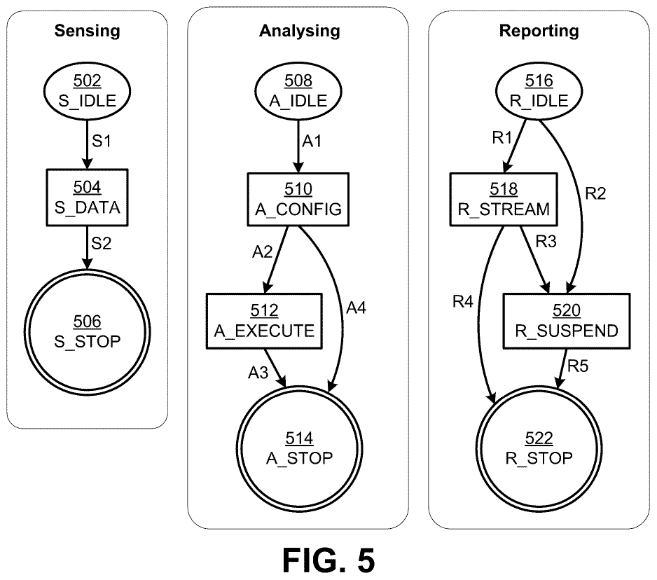

FIG. 5 is an illustrative WTRU-based sensing functionalities state machine diagram, according to some embodiments of this disclosure. The WTRU sensing functionalities are shown and described as being three different state machines (e.g., sensing, analyzing, and reporting) for simplicity. However, the functionality may be implemented in a single state machine or as one or more functions (e.g., an analyzing function).

Sensing may refer to the WTRU (e.g., WTRU 102a, 102b, 102c, 201) performing sensing by generating sensing data, sensing results, contextual information, or any combination thereof.

Analyzing may refer to the WTRU performing analytics over sensing data and/or sensing results. This covers cases in which WTRUs generate sensing results based on statistical processing, ML-based analytics, any other means of processing sensing data into sensing results, or any combination thereof.

Reporting may refer to the WTRU transmitting sensing data and/or sensing results, with or without associated contextual information, to an Access Node (AN) and/or CN.

For each of the state machines, different definitions and transitions are considered.

In accordance with some embodiments of this disclosure, for the sensing state machine, the state definitions are provided as follows: S_IDLE 502, S_DATA 504, and S_STOP 506. S_IDLE 502 may indicate that the WTRU is ready to receive configuration information from the CN, to start sensing (WTRU has registered capabilities with CN), and is awaiting a request/configuration to perform sensing. S_DATA 504 may indicate that the WTRU is performing sensing by generating sensing data, sensing results, contextual information, or any combination thereof. S_STOP 506 may indicate that the WTRU stops performing the sensing task. This state releases all states and resources related to the sensing task in the WTRU.

The transitions for the sensing state machine are provided as follows: S1 and S2. The S1 (S_IDLE 502 to S_DATA 504) transition may be performed for cases in which WTRU receiving a request to perform a sensing task for which it did not conduct any sensing signal transmission or reception. The S2 (S_DATA 504 to S_STOP 506) transition may be performed for cases in which the WTRU receiving a request to stop performing the sensing task.

In accordance with some embodiments of this disclosure, for the analyzing state machines, the state definitions are provided as follows: A_IDLE 508, A_CONFIG 510, A_EXECUTE 512, and A_STOP 514. A_IDLE 508 may refer to cases in which no analytics are being performed at the WTRU. A_CONFIG 510 may refer to states in which the WTRU parses a configuration for performing analytics over sensing data or sensing results. A_EXECUTE 512 may refer to cases in which the WTRU performs analytics over sensing data, sensing results, contextual information associated with the sensing data and/or sensing results, or any combination thereof. A_STOP 514 may refer to cases in which the WTRU stops performing analytics over sensing data, sensing results, contextual information, or any combination thereof.

In accordance with some embodiments of this disclosure, the transitions for the analyzing state machines are provided as follows: A1, A2, A3, and A4. The A1 (A_IDLE 508 to A_CONFIG 510) transition may be performed for cases in which the SAF (e.g., SAF 188a, 188b) functionality in the 6GS detects sensing KPI requirement violation and the SCF (e.g., 187a, 187b) sends an indication to the WTRU to perform analytics over sensing data and/or sensing results, or for the WTRU to assess the KPI requirements of the sensing results. The WTRU may verify whether configuration is consistent with WTRU sensing capabilities. The A2 (A_CONFIG 510 to A_EXECUTE 512) transition may be performed for cases in which the WTRU validates configuration successfully. The A3 (A_EXECUTE 512 to A_STOP 514) transition may be performed for cases in which conditions provided by the SAF for exiting the monitoring state are met. The A4 (A_CONFIG 510 to A_STOP 514) transition may be performed for cases in which an error in configuration file, (e.g., analytics operations requested) are not a match with WTRU capabilities.

In accordance with some embodiments of this disclosure, for the reporting state machine, the state definitions are provided as follows: R_IDLE 516, R_STREAM 518, R_SUSPEND 520, and R_STOP 522. R_IDLE 516 may refer to cases in which the WTRU is waiting for SAF to provide criteria for reporting to be met. In such cases, the WTRU may not report. R_STREAM 518 may refer to cases in which the WTRU reports to the NW on sensing data, sensing results, contextual information, or any combination thereof. R_SUSPEND 520 may refer to cases in which the WTRU may not report any sensing data or sensing results. R_STOP 522 may refer to cases in which the WTRU stops the reporting of sensing data, sensing results, contextual information, or any combination thereof.

In accordance with some embodiments of this disclosure, the transitions for the reporting state machines are provided as follows: R1, R2, R3, R4, and R5. The R1 (R_IDLE 516 to R_STREAM 518) transition may be performed for cases in which configured reporting criteria is met or no criteria is configured. In such cases, the WTRU may start reporting sensing data. The R2 (R_IDLE 516 to R_SUSPEND 520) transition may be performed for cases in which the network sent reporting criteria to the WTRU and the configured reporting criteria are not met. The R3 (R_STREAM 518 to R_SUSPEND 520) transition may be performed for cases in which the SAF functionality in the 6GS detected a sensing KPI requirement violation and sends an indication to the WTRU to be in monitoring. In such cases, the WTRU may not report on sensing data. The R4 (R_STREAM 518 to R_STOP 522) transition may be performed for cases in which the WTRU stops the reporting of sensing data, sensing results, contextual information, or any combination thereof (e.g., due to an indication from the NW). The R5 (R_SUSPEND 520 to R_STOP 522) transition may be performed for cases in which the WTRU stops the reporting of sensing data, sensing results, contextual information, or any combination thereof (e.g., due to an indication from the NW).

In accordance with some embodiments of this disclosure, methods and systems for activation and de-activation of sensing reporting and/or sensing analytics are provided as follows.

Sensing KPIs may be defined differently for different use cases. This may be because different use cases require involvement of different sensing sources (e.g., WTRUs), and the information that can be extracted from sensing and that is relevant to a use case may greatly vary.

Execution of an assessment of sensing KPIs over sensing results may include at least one of threshold-based configurations, assessment of statistically processed or AI/ML processed sensing results, or situational awareness assessments.

In some embodiments, if the WTRU is assessing criteria for performing analytics, the WTRU may be considered to be in state A_EXECUTE 512. If the WTRU is not assessing criteria for performing analytics, the WTRU may be considered to be in state A_IDLE 508. If the WTRU is assessing this criteria and sending sensing reports, it may be considered to be concurrently in state R_STREAM 518. If the WTRU is not assessing this criteria and not sending sensing reports, the WTRU may be considered to be in state R_SUSPEND 520. The WTRU may be configured to report on analytics and sensing reporting concurrently, one of the options at a time, or none of the options. This configuration may be controlled by the network in step 6 of FIG. 4 and may be triggered by determination of the at least one criteria by the WTRU in step 8 of FIG. 4.

In accordance with some embodiments of this disclosure, examples of criteria for sensing data are provided as follows.

Threshold-based configurations for sensing data may include one or more of the metrics that are considered sensing data. The configuration of these metrics may include intervals, static and/or relative values. For example, the configuration of these metrics may be the WTRU determining Down Link (DL) reference signal time difference (DL RSTD) using signals coming from different Transmission Reception Points (TRPs) and sidelink Rx-Tx time difference. This would have the WTRU determining the time difference between all TRPs and other WTRUs with an active sidelink connection. By providing the WTRU with thresholds on these measurements, this could serve as a method to exclude one or more sensing sources. The WTRU may determine sensing KPI requirements are not being met, for example, if one or more sensing sources are excluded by this configuration because the sensing data is not sufficiently good for the sensing results to meet the requirements. Due to the complexity of sensing use cases and applications that benefit from these assessments, it is worth pointing out that all combinations of one or more metrics, and providing intervals, and/or static values, and/or relative values, are possible to determine sensing KPIs are being met or not. Evaluations over sensing data may be particularly useful in digital twinning situations, where the CN may have an accurate twin of the physical scenario, and requires more precise information about the propagation environment.

In accordance with some embodiments of this disclosure, example criteria for sensing results are provided as follows.

In terms of sensing results, Range-Angle-Doppler (RAD) tensors can be given as examples. These tensors contain useful information about range and angle towards objects, and may be more or less complex, depending on the scenario and use case. For example, the RAD tensor may provide information about number of detected objects, and their relative position and velocity in relation to the WTRU that is generating sensing results for the assessment of obstacles or vehicles on a road. The RAD tensor may contain more information if there are more objects detected. The RAD tensor may be less accurate if, for example, a certain number of objects are in the same area and the WTRU cannot accurately count them (i.e., object resolution). The evaluation of sensing KPIs in this case may be directed at specific characteristics provided by the information in a RAD tensor. For example, if relative velocity towards an object is higher than a threshold, as extracted from the RAD tensor, the relative velocity value may itself be deemed not meeting sensing KPI(s). In some embodiments, the estimated error of the velocity value extracted from the RAD tensor may be too high, and the sensing result estimation (e.g., the velocity) may not be suitable and may not meet KPI requirements. In some embodiments, if the relative position of an object in relation to the WTRU is outside of particular bounds (e.g., the radius of a circle), then the WTRU may not meet sensing KPI(s).

Situational awareness assessment may be considered targeting sensing results. The system may be interested in the WTRU detecting a particular kind of object that is not present in the physical scenario in a given moment. In some embodiments, the system may only be interested in receiving sensing data, sensing results, and their contextual information from a WTRU if the direction of a particular object in relation to the WTRU is bounded by a particular angle (e.g., an area within a wider area being sensed). While an object and/or a WTRU move, the relative angle between them can be measured. If the sensing information gathered from a relative angle is not suitable for a particular use case, this may be considered as sensing KPI(s) not being met. In some embodiments, if the estimated angle from sensing data does not meet accuracy criteria, then the angle as a sensing result may be deemed to not meet sensing KPI requirements.

In accordance with some embodiments of this disclosure, example criteria for analytics purposes are provided as follows.

Statistically processed or AI/ML processed sensing data and sensing results may be analyzed. This may mean that the WTRU batches any number of samples together, applies statistical methods to derive functions that describe a batch, determines function parameters, or any combination thereof. Sensing KPIs may be determined by, for example, the WTRU analyzing one or more samples of sensing data, sensing results, their contextual information, or any combination thereof, and concluding whether they fall within a certain statistical function, or if those samples are seen as outliers. Statistical functions may also be used to obtain characteristics of collected sensing data, sensing results, their contextual information, such as number of samples within a certain range, number of outliers, skewness of a distribution function, or any combination thereof, and this can be done over a multitude of metrics, such as angle of arrival, orientation, velocity estimation, position estimation, or any combination thereof. Contextual information may also be subject to these methods, allowing, for example, for deriving time patterns, counting number of occurrences of a sensing result within a certain time interval, or any combination thereof.

The WTRU may apply AI/ML supervised or unsupervised methods on sensing data, sensing results, their contextual information, or any combination thereof. For supervised methods, this may help clustering sensing data, sensing results, their contextual information, or any combination thereof into different categories. For example, a category may be “usable TRP list” vs “non-usable TRP list”. The WTRU may use any metric described for sensing data to cluster TRPs. For unsupervised learning, the WTRU may, for example, create new categories based on its sensing data, sensing results, their contextual information, or any combination thereof. Examples of new categories created could be, for example, “reportable object” vs “non-reportable object”, wherein the WTRU may classify objects that would be suitable or not to report.

AI/ML methods may play a role in the development of sensing results. Their clustering, classification, and predictive capabilities may be used to generate more complex sensing results. For example, the model(s) may take a few past samples of angle of arrival, orientation, velocity, position, or any combination thereof and predict a few next values of those same inputs. In some embodiments, the input could be an angle, orientation, object type. The output may yield a specific sensing result (e.g., path derivation in a factory where robots are avoiding each other). In some embodiments, it would be possible to derive such a result with knowledge from the factory floor plan, and information about the objects there. For example, knowledge obtained a priori or generated via sensing of unmovable objects such as pillars or factory racks could be used to classify areas in the factory's floor plan. This knowledge may be built using sensing as a feature or by, for example, pre-configuring a DT where a factory floor plan is designed. The model(s) may classify samples taken as input, in terms of their suitability for the sensing goal. For example, an angle of arrival may be the input to the model. The output of the model may be a classification of the angle of arrival being out of bounds (for a given Sensing goal where the angle plays a role). In some embodiments, the position of a certain object or a sensing receiver/transmitter may be the output of a model that receives as inputs the material from a few sensed objects, and/or the relative angles from the object to the transmitter/receiver.

These examples are not exhaustive as there are many possibilities for model outputs, and the model does not necessarily need to be of AI/ML type. The purpose is to illustrate with a few examples what can be derived as a sensing result after at least one round of processing from raw sensing data, and what could potentially done thereafter, with the goal of serving a sensing application.

To any of the described methods, any metric related to integrity, confidence, and/or accuracy can be applied. This can dictate as well if sensing KPI(s) are being met or not. Taking the angle example above, the WTRU may determine whether the angle is within bounds to report but if the integrity, confidence, and/or accuracy of that determination is under a certain desired value, then sensing KPI(s) may be met.

The assessments may be performed in the CN. The WTRU entering a A_EXECUTE state may be seen as a transfer of some of the SAF functionalities, in this case the sensing KPI assessment functionality, to the WTRU, at least temporarily. However, nothing precludes the configuration of the assessment to be different (in any measure) than the one happening at the NW. All of the examples given may be configured in the WTRU and the WTRU may report on them.

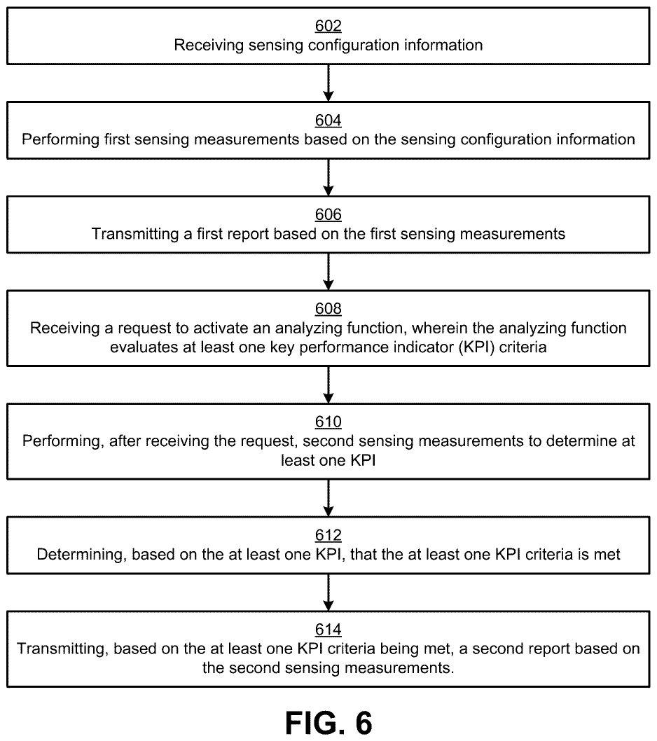

FIG. 6 is an illustrative flow diagram of steps for WTRU sensing monitoring in wireless systems, according to some embodiments of this disclosure.

At step 602, the WTRU (e.g., WTRU 102a, 102b, 102c, 201) may receive sensing configuration information. The sensing information may be received from the SCF (e.g., SCF 187a, 187b, 206). In some embodiments, the sensing configuration information comprises the at least one KPI criteria.

At step 604, the WTRU may perform first sensing measurements based on the sensing configuration information.

At step 606, the WTRU may transmit a first report based on the first sensing measurements. The first report may be transmitted to the SAF (e.g., SAF 188a, 188b, 208).

At step 608, the WTRU may receive a request to activate an analyzing function, wherein the analyzing function may evaluate at least one KPI criteria. In some embodiments, the analyzing function corresponds to the analyzing state machine of FIG. 5. In some embodiments, the analyzing function corresponds to sensing functionalities state machine diagram of FIG. 5. In some embodiments, the request may be received from the SCF (e.g., based on a detection of a KPI violation). In some embodiments, the WTRU may suspend, after receiving the request, transmission of sensing reports. In some embodiments, the request to activate the analyzing function comprises an indication of the at least one KPI criteria.

At step 610, the WTRU may perform, after receiving the request, second sensing measurements to determine at least one KPI. In some embodiments, the at least one KPI comprises an error metric and the at least one KPI criteria comprises a threshold value for the error metric.

At step 612, the WTRU may determine, based on the at least one KPI, that the at least one KPI criteria is met. In some embodiments, determining that the at least one KPI criteria is met is based on an output of a machine learning model.

At step 614, the WTRU may transmit, based on the at least one KPI criteria being met, a second report based on the second sensing measurements.

In some embodiments, the WTRU may transmit, after determining that the at least one KPI criteria is met at step 612, an indication that the at least one KPI criteria is met. In some embodiments, the indication that the at least one KPI criteria is met is sent to the SCF.

In some embodiments, the WTRU may receive, after transmitting the indication that the at least one KPI criteria is met and before transmitting the second report at step 614, a request to start transmitting sensing reports. The request to start transmitting sensing reports may be received from the SCF.

In some embodiments, the first report and/or the second report are transmitted to a sensing analytics function of a core network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “WTRU”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving sensing configuration information;
performing first sensing measurements based on the sensing configuration information;
transmitting a first report based on the first sensing measurements;
receiving a request to activate an analyzing function, wherein the analyzing function evaluates at least one key performance indicator (KPI) criteria;
performing, after receiving the request, second sensing measurements to determine at least one KPI;
determining, based on the at least one KPI, that the at least one KPI criteria is met; and
transmitting, based on the at least one KPI criteria being met, a second report based on the second sensing measurements.

2. The method of claim 1, further comprising:
suspending, after receiving the request, transmission of sensing reports.

3. The method of claim 1, further comprising:
transmitting, after determining that the at least one KPI criteria is met, an indication that the at least one KPI criteria is met.

4. The method of claim 3, further comprising:
receiving, after transmitting the indication that the at least one KPI criteria is met and before transmitting the second report, a request to start transmitting sensing reports.

5. The method of claim 1, wherein the request to activate the analyzing function is based on a detection of a KPI violation.

6. The method of claim 1, wherein determining that the at least one KPI criteria is met is based on an output of a machine learning model.

7. The method of claim 1, wherein:
the at least one KPI comprises an error metric; and
the at least one KPI criteria comprises a threshold value for the error metric.

8. The method of claim 1, wherein the request to activate the analyzing function comprises an indication of the at least one KPI criteria.

9. The method of claim 1, wherein the sensing configuration information comprises the at least one KPI criteria.

10. The method of claim 1, wherein the first report and the second report are transmitted to a sensing analytics function of a core network.

11. A wireless transmit/receive unit (WTRU) that is in communication with a wireless network, the WTRU comprising a processor and a transceiver, wherein the WTRU is configured to:
receive sensing configuration information;
perform first sensing measurements based on the sensing configuration information;
transmit a first report based on the first sensing measurements;
receive a request to activate an analyzing function, wherein the analyzing function evaluates at least one key performance indicator (KPI) criteria;
perform, after receiving the request, second sensing measurements to determine at least one KPI;
determine, based on the at least one KPI, that the at least one KPI criteria is met; and
transmit, based on the at least one KPI criteria being met, a second report based on the second sensing measurements.

12. The WTRU of claim 11, further configured to:
suspend, after receiving the request, transmission of sensing reports.

13. The WTRU of claim 11, further configured to:
transmit, after determining that the at least one KPI criteria is met, an indication that the at least one KPI criteria is met.

14. The WTRU of claim 13, further configured to:
receive, after transmitting the indication that the at least one KPI criteria is met and before transmitting the second report, a request to start transmitting sensing reports.

15. The WTRU of claim 11, wherein the request to activate the analyzing function is based on a detection of a KPI violation.

16. The WTRU of claim 11, wherein determining that the at least one KPI criteria is met is based on an output of a machine learning model.

17. The WTRU of claim 11, wherein:
the at least one KPI comprises an error metric; and
the at least one KPI criteria comprises a threshold value for the error metric.

18. The WTRU of claim 11, wherein the request to activate the analyzing function comprises an indication of the at least one KPI criteria.

19. The WTRU of claim 11, wherein the sensing configuration information comprises the at least one KPI criteria.

20. The WTRU of claim 11, wherein the first report and the second report are transmitted to a sensing analytics function of a core network.
